(19) United States
(12) Patent Application Publication
(10) Pub. No.: US 2026/0127518 A1
(43) Pub. Date: May 7, 2026

(54) POSITIONING SYSTEM

(71) Applicant: TOYOTA JIDOSHA KABUSHIKI KAISHA, Toyota-shi (JP)

(72) Inventor: Tomohiro TSUBOTA, Nagoya-shi (JP)

(73) Assignee: TOYOTA JIDOSHA KABUSHIKI KAISHA, Toyota-shi (JP)

(21) Appl. No.: 19/343,501

(22) Filed: Sep. 29, 2025

(30) Foreign Application Priority Data
Nov. 5, 2024 (JP) 2024-193480

(51) Int. Cl. G06Q 10/0631; G02B 27/00

(52) U.S. Cl. CPC G06Q 10/063114; G02B 27/0093

(57) ABSTRACT

A positioning system positioning a worker, comprising: a posture sensor worn by the worker, the posture sensor detecting a physical quantity relating to a change in posture of the worker; an optical tracker device optically detecting a physical quantity representing a position of a tracker worn by the worker; and a position identification unit identifying a position of the worker by selectively using at least one detection result of first detection result by the posture sensor and second detection result by the optical tracker device in a plurality of patterns.

### CROSS REFERENCE TO RELATED APPLICATIONS

The present application claims priority based on a Japanese patent application, application number 2024-193480, filed November 5, 2024, the entire disclosure of which is incorporated herein by reference.

### BACKGROUND

### FIELD

This disclosure relates to a positioning system.

### RELATED ART

Regarding a positioning system for positioning a worker, International Publication No. 2018/087844 discloses a technique for recognizing an operation performed by the worker using position coordinates of a body part of the worker acquired using a sensor.

In the positioning system positioning the worker, a technique to ensure positioning accuracy and the positioning robustness is desired.

### SUMMARY

According to one aspect of the present disclosure, a positioning system positioning a worker is provided. The positioning system includes: a posture sensor worn by the worker, the posture sensor detecting a physical quantity relating to a change in posture of the worker; an optical tracker device optically detecting a physical quantity representing a position of a tracker worn by the worker; and a position identification unit identifying a position of the worker by selectively using at least one detection result of first detection result by the posture sensor and second detection result by the optical tracker device in a plurality of patterns.

### BRIEF DESCRIPTION OF THE DRAWINGS

FIG. 1 is an explanatory diagram showing a schematic configuration of a positioning system in the first embodiment;

FIG. 2 is a flow chart of the position identification process in the first embodiment;

FIG. 3 is a diagram illustrating an exemplary position identification process in the first embodiment;

FIG. 4 is a flow chart of the position identification process in the second embodiment;

FIG. 5 is a diagram for explaining an exemplary position identification process in the second embodiment.

### DETAILED DESCRIPTION

### A. First Embodiment

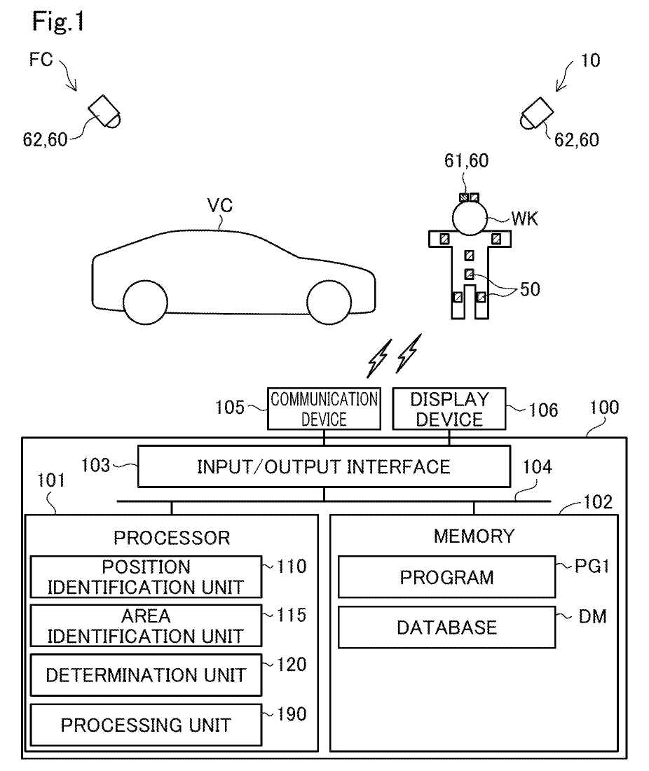

FIG. 1 is an explanatory diagram showing a schematic configuration of a positioning system 10 in the first embodiment. The positioning system 10 is used to position a worker WK performing an operation. The positioning system 10 is used in a workshop where the worker WK performs the operation. The workshop in this embodiment is a factory FC for manufacturing a vehicle VC. The operation in the present embodiment is a variety of operations for manufacturing the vehicle VC, including, for example, assembly of the vehicle VC, assembly of components to the vehicle VC, and inspecting the vehicle VC.

The positioning system 10 comprises a posture sensor 50, an optical tracker device 60 and a position identification device 100.

The posture sensor 50 is worn by the worker WK. In the present embodiment, the posture sensor 50 is mounted one by one on the head, the right arm, the left arm, the chest, the abdomen, the right leg and the left leg of the worker WK. The posture sensor 50 is configured to be capable of detecting physical quantity relating to change in posture of the worker WK. More specifically, the posture sensor 50 detects accelerations and angular velocities occurring in the worker WK as the physical quantity relating to the change in the posture of the worker WK. In the present embodiment, the posture sensor 50 is configured as an inertial measuring device (IMU) including a three-axis acceleration sensor, a three-axis gyro sensor, and a three-axis geomagnetic sensor. The present detection result by the posture sensor 50 is also referred to as "first detection result". The first detection result is associated with information representing timing in which the first detection result is detected. The posture sensor 50 transmits the detected first detection result to the position identification device 100.

The optical tracker device 60 has a tracker 61 and a base station 62. The optical tracker device 60 is configured to be capable of optically detecting physical quantity representing the position of the tracker 61 worn by the worker WK. In the present embodiment, the single tracker 61 is worn by the worker WK. More specifically, in the present embodiment, the single tracker 61 is mounted on the head of the worker WK. The body part on which the tracker 61 is worn may be optional, but is preferably a body part that does not easily hinder the operation such as the head. The detection result by the optical tracker device 60 is also referred to as second detection result. The second detection result is associated with information representing timing in which the second detection result is detected.

In the factory FC, the base station 62 is located in the vicinity of the area where the operation by the worker WK is to be performed. In the present embodiment, two base stations 62 are arranged in the factory FC. The base station 62, at predetermined time-intervals, emits detection light for detecting the position of the tracker 61. The detection light is scanned within the irradiation range of the detection light. The detection light includes, for example, an infrared laser beam. The tracker 61 includes a light receiver configured by a photodiode or the like, and a communication device. The tracker 61 receives the detection light emitted from the base station 62. when receiving the detection light, The tracker 61 transmits the received light information as a second detection result to the position identification device 100. The received light information includes information representing time until the detected light from the base station 62 is received by the tracker 61. As a result, the position of the tracker 61 can be uniquely identified using the received light information. Thus, the received light information accurately represents the position of the tracker 61. As described above, the detecting method using the base station 62 is also referred to as a "Lighthouse method". In other embodiments, the optical tracker device 60 may optically detect physical quantity relating to the position of the tracker 61 in a manner not limited to the Lighthouse method.

The position identification device 100 is configured as a computer with a processor 101, a memory 102, an input/output interface 103 and an internal bus 104. The processor 101, the memory 102, and the input/output interface 103 are connected each other via the internal bus 104 so as to be able to communicate in both directions each other. The input/output interface 103 is connected to the communication device 105 and the display device 106. The communication device 105 may communicate with the posture sensor 50 and the optical tracker device 60 via wired or wireless communication. The communication device 105 in the present embodiment corresponds to a "receiving unit" in the present disclosure. The receiving unit is configured to be capable of receiving the first detection result from the posture sensor 50 and the second detection result from the optical tracker device 60. The display device 106 is configured by, for example, a liquid crystal display or the like, and displays various information such as information on positioning results by the positioning system 10. The memory 102 stores a variety of data such as a program PG1 and a database DM. The processor 101 implements various functions, including functions as a position identification unit 110, an area identification unit 115, a determination unit 120, and a processing unit 190, by executing the program PG1.

The position identification unit 110 is configured to be capable of identifying a position of the worker WK using at least one detection result of the first detection result and the second detection result selectively in a plurality of patterns. More specifically, the position identification unit 110 identifies the position of the worker WK using the detection result received by the communication device 105 as the receiving unit. In the present embodiment, the position identification unit 110 selectively uses at least one detection result of the first detection result and the second detection result in a plurality of patterns according to an area in which the worker WK is located. Here, The "plurality of patterns" includes two or more patterns among a first pattern, a second pattern and a third pattern. The first pattern is a pattern using only the first detection result but not using the second detection result. The second pattern is a pattern using the second detection result but not using the first detection result. The third pattern is a pattern using the first detection result and the second detection result. In the present disclosure, unless otherwise specified, "using the detection result" means that "the current detection result" is used in a timely manner. The "current detection result" means the detected result obtained by timing when positioning is performed or by timing when very close to the timing. In the present embodiment, the position identification unit 110 selectively uses the first pattern and the third pattern.

In the present embodiment, the position identification unit 110 performs one of the first process and the second process in accordance with an area where the worker WK is located. The first process is a positioning process in which the position of the worker WK identified using the first detection result and without using the second detection result. The second process is a positioning process in which the position of the worker WK is identified using the first detection result and the second detection result. In the second process, the first detection result and the second detection result corresponding temporally to each other are used. In the present embodiment, the position identification unit 110 identifies the positions of various body parts of the worker WK including the joints, the head, and the feet of the worker WK as the positions of the worker WK. In the present embodiment, the foot position identified by the position identification unit 110 is used as the present position of the worker WK. More specifically, the position of the midpoint of the line segment connecting the heels of both feet of the worker WK is used as the present position of the worker WK. In other embodiments, the position of any body part of the worker WK may be identified as the position of the worker WK, not limited to the joint or the head or the foot. A process of positioning the worker WK, such as the first process and the second process, is also referred to as the "positioning process".

In the first process in the present embodiment, the position identification unit 110 identifies the position of the worker WK based on displacement from a reference position using the reference position and the first detection. More specifically, in the first process, the position identification unit 110, for example, calculates motion acceleration of the worker WK using the acceleration and the posture detected using the posture sensor 50, calculates the displacement from the reference position using the integral of the calculated motion acceleration, and identifies the position of the worker WK based on the calculated displacement. More specifically, the displacement from the reference position is calculated by the double time integration of the operational acceleration. The posture of the worker WK is detected using the integral of the angular velocity, more specifically, using the acceleration and the integral of the angular velocity. In the first process, if there is a previous position, the previous position is used as the reference position. The previous position is the position of the worker WK as a previous positioning result. The previous position may be a position as a positioning result by the first process or a position as a positioning result by the second process. When the first processes are executed two or more times continuously, in each first process, the previous position is used cumulatively. If there is no previous position, a predetermined default position is used as the reference position.

In the present embodiment, the position identification unit 110 uses, as the reference position, the position of the foot of the worker WK, more specifically, the position of the midpoint of the line segment connecting the heels of both feet of the worker WK. Here, the worker WK moves in the factory FC by walking with at least one of the right and left feet touching the ground. Therefore, when identifying the worker WK position based on the variation from the reference position as in the first process, by identifying the worker WK foot position as the reference position, the position of the worker WK can be identified more accurately than when using as the position of the body part which is easy to move regardless of walking, for example, head or hand/arm, as the reference position. In addition, the worker WK is likely to perform operations in the factory FC with the position of at least one of the right and left feet fixed. Therefore, as described above, by using the position of the foot of the worker WK as the present position of the worker WK, for example, the subsequent process by the processing unit 190 described below can be performed more appropriately. In this way, the position of the foot of the worker WK is identified as the position of the worker WK, so that more accurate and valuable positioning result can be obtained.

In the second process according to the present embodiment, the position identification unit 110 identifies the position of the worker WK using the posture detected using the posture sensor 50 and the position of the tracker 61 detected using the optical tracker device 60. In other words, in the second process, the position identification unit 110 identifies the positions of the joints, the head, and the feet of the worker WK using the positions of the head of the worker WK and the posture of the worker WK. In the second process, the first detection result and the second detection result are used, so that the position of the body part that differs from the body part to which the tracker 61 is worn can be identified as the position of the worker WK. In the second process, for example, the body size information of the worker WK previously stored in the memory 102 may be used to identify the position of the worker WK. The body size information is information that represents the body size, such as the height and breadth of the worker WK.

In the positioning process using the second detection result as the second process, the position of the tracker 61 that can be acquired without being affected by drifting is used. In addition, unlike the first process, in the second process, the position of the worker WK is identified without integrating the motion acceleration, and the reference position is not used. As a result, in the positioning process using the second detection result, the effect of drifting on the positioning result is more suppressed, and a decrease in the positioning accuracy is more suppressed than the positioning process that does not use the second detection result, that is, positioning process using the reference position, as in the first process. However, compared with the first detection result, the second detection result is more likely to be affected by disturbances, such as obstacles that block the detection light depending on the position of the worker WK, and therefore tends to have lower robustness. Therefore, if only the positioning process using the second detection result is performed in the positioning system 10, the robustness of the positioning in the positioning system 10 may decrease. Therefore, in the present embodiment, at least one detection result of the first detection result and the second detection result is selectively used, thereby achieving compatibility between the positioning accuracy and the robustness of the positioning. When the first process is executed immediately after the second process, the position of the worker WK identified in the immediately preceding second process is used as the reference position in the first process immediately after the second process.

The area identification unit 115 identifies an area in which the worker WK is located. The area identification unit 115 identifies the area where the worker WK is located, for example, using an external sensor (not shown) such as an area sensor or a camera installed in the factory FC. The external sensor is located outside the worker WK and can identify the worker WK area.

The determination unit 120 determines which positioning process of the first process and the second process is performed in accordance with the area identified by the area identification unit 115. More specifically, the determination unit 120 determines which positioning process of the first process and the second process is executed by referring to the database DM based on identification information of the identified area. In the database DM, identification information of each area in the factory FC and information indicating either the first processing or the second processing as a positioning process are stored in association with each other.

The processing unit 190 executes a subsequent process using the positioning result in the positioning system 10. The subsequent processing is processing for utilizing the positioning result, and includes, for example, analysis process for analyzing the positioning result and generation process for generating a digital model based on the positioning result. In the analysis process, the processing unit 190 analyzes, in real time or a posteriori, the appropriateness of the status of the worker WK at the workshop and the appropriateness of the movement and the manner of the operation by comparing, for example, the locus of the movement of the worker WK based on the positioning result, that is, the locus of the present position of the worker WK, and the locus of the predetermined criterion. Such analysis processing may be used, for example, for quality assurance of products produced in a workshop or for safety evaluation of work in a workshop. In the generation process, the processing unit 190 may generate the digital model that reproduces the worker WK movements and operations in a digital space that simulates the factory FC, for example. The processing unit 190 may, for example, cause the display device 106 to show the process resulting from the subsequent process. The content of the subsequent process is not limited to the above.

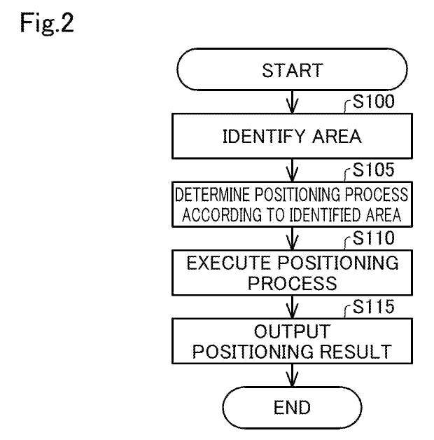

FIG. 2 is a flow chart of a position identification process. The position identification process may be performed by the processor 101 of the position identification device 100 at predetermined time-intervals, for example, or may be performed by the timing on which the first detection was received by the communication device 105.

In step S100 of FIG. 2, the area identification unit 115 identifies the area where the worker WK is located. In step S105, the determination unit 120 determines which positioning process of the first process and the second process is performed according to the area identified in step S100. In step S110, the position identification unit 110 identifies the position of the worker WK by performing the positioning process determined by step S105. More specifically, in step S110, the position identification unit 110 performs a first process using the most recent first detection result received by the communication device 105, or alternatively performs a second process using the first detection result and the second detection result that correspond temporally to each other received by the communication device 105. In step S110, the position identification unit 110 records the position identified by the positioning process in the memory 102 as the positioning result. In step S115, the position identification unit 110 outputs the positioning result. More specifically, in step S115, the position identification unit 110 causes the positioning result to be displayed on the display device 106 or causes the processing unit 190 to perform a subsequent process.

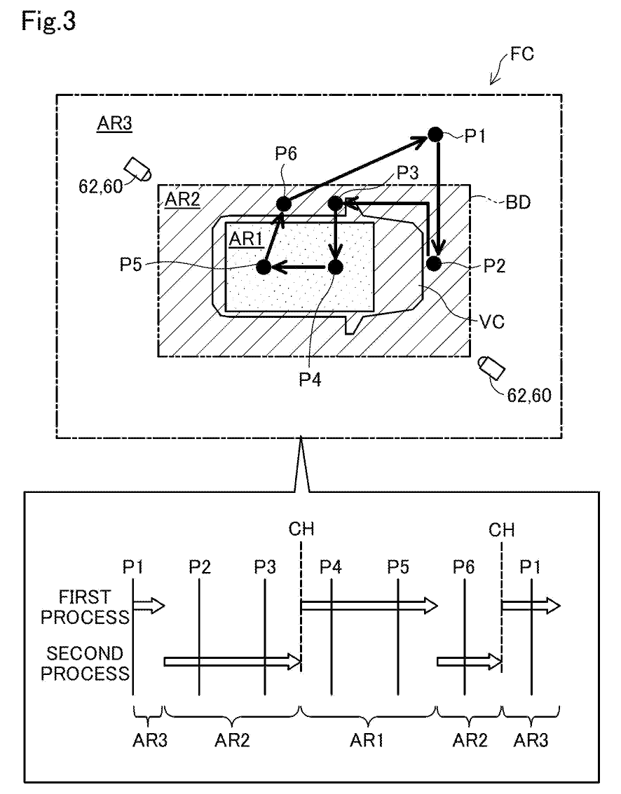

FIG. 3 is a diagram illustrating an exemplary position identification process in the present embodiment. FIG. 3 is a top view showing the worker WK moving cyclically through positions P1, P2, P3, P4, P5, and P6 in this order. In the example of FIG. 3, the worker WK performs a series of operations relating to the vehicle VC while moving between the respective positions. In FIG. 3, the trajectory of the movement of the worker WK is indicated by a bold line. In the example of FIG. 3, the first processing is executed when the worker WK is located in the first area AR1 and when the worker WK is located in the third area AR3, and the second processing is executed when the worker WK is located in the second area AR2. In FIG. 3, the first area AR1 is hatched with dotted patterns and the second area AR2 is hatched with diagonal lines. In FIG. 3, a boundary BD between the second area AR2 and the third area AR3 is shown by the two-dot chain line.

In the example of FIG. 3, the first area AR1 corresponds to a region inside the vehicle cabin of the vehicle VC. The first area AR1 is located within an irradiation range of the detection light from the base station 62. However, because the first area AR1 is a region inside the vehicle cabin, at least a part of the first area AR1 becomes a blind spot in the irradiation range of the detection light, due to the detection light being blocked by the vehicle body such as a roof, a pillar, or a door of the vehicle VC. In such a blind spot, since the second detection result is not detected, it is difficult to appropriately execute the second process. In this way, the first area AR1 is an area where the second detection is difficult to detect. Accordingly, when the worker WK is located in the first area AR1, by executing the first processing, it is possible to suppress execution of the second processing in the first area AR1 where the second detection result is less likely to be obtained, thereby enabling the worker WK to be positioned with higher accuracy.

In the example shown in FIG. 3, the second area AR2 corresponds to an area outside the vehicle cabin of the vehicle VC that is relatively near the vehicle VC. The second area AR2 is located on the outer side of the first area AR1 so as to surround the periphery of the first area AR1 in a top view. The second area AR2 is located within the irradiation range of the detected beam. Since the second area AR2 is a region outside the vehicle cabin, each part within the second area AR2 is less likely to become a blind spot in the irradiation range of the detection light. In this way, the second area AR2 is an area in which the second detection is more likely to be detected compared with the first area AR1. Accordingly, when the worker WK is located in the second area AR2, by executing the second processing, it is possible to suppress the influence of drift on the positioning result as compared with a case where the first processing is executed in the second area AR2, thereby enabling the worker WK to be positioned with higher accuracy.

In the example shown in FIG. 3, the third area AR3 corresponds to an area outside the vehicle cabin that is relatively far from the vehicle VC. The third area AR3 is located on the outer side of the second area AR2 so as to surround the periphery of the second area AR2 in a top view. The third area AR3 is located outside the irradiation range of the detected beam. As a result, in the third area AR3, since the second detection result is not detected, it is difficult to appropriately execute the second process. Therefore, when the worker WK is located in the third area AR3, the first process is executed, so that the worker WK can be positioned with higher accuracy.

According to the positioning system 10 of the present embodiment described above, since the position of the worker WK is identified by selectively using at least one of the first detection result, which is stably detectable regardless of the position of the worker WK by the posture sensor 50, and the second detection result, which accurately represents the position of the tracker 61, it is possible to ensure both positioning accuracy and robustness of positioning in the positioning system 10.

In the present embodiment, at least one detection result of the first detection result and the second detection result is selectively used for positioning in accordance with the area where the worker WK is located. Therefore, positioning accuracy and positioning robustness in the positioning system 10 can be ensured by using appropriate detection result according to the area where the worker WK is located. Furthermore, in the present embodiment, since the detection result used for positioning can be managed for each area, for example, when an abnormality occurs in the positioning result by the positioning system 10, it can be more easily identified whether the cause of the abnormality is the posture sensor 50 or the optical tracker device 60.

In the present exemplary embodiment, one of the first process and the second process is executed in accordance with the area where the worker WK is located. Therefore, when the worker WK is located in an area where the second detection result is hard to be detected, the first process is executed, so that the reduction in the robustness of the positioning can be suppressed. On the other hand, when the worker WK is located in an area where the second detection is likely to be detected, the worker WK can be positioned with high accuracy by executing the second process.

In the present embodiment, the position identification unit 110 identifies the position of the worker WK by using the first detection result and the second detection result in the second process. Therefore, in the second process, the position of the body part that differs from the body part on which the tracker 61 is located can be identified as the position of the worker WK, thereby increasing the convenience of the positioning system 10. In particular, in the present embodiment, in the second process, at least the position of the foot of the worker WK is identified using the posture of the worker WK calculated using the first detection result and the position of the head of the worker WK represented by the second detection result. As a result, it is possible to obtain a positioning result with higher accuracy and usefulness while preventing the operation of the worker WK from being inhibited by the mounted the tracker 61.

In the present exemplary embodiment, when the first process is executed immediately after the second process, the position identification unit 110 identifies the position of the worker WK by using the position of the worker WK identified by the second process immediately before as the reference position and calculating the displacement from the reference position using the first detection result. That is, as shown in FIG. 3, at the timing CH immediately after the positioning process is switched from the second process to the first process, the positioning result of the second process immediately before is used as the reference position of the first process. Therefore, in the first process, it is possible to suppress a decrease in positioning accuracy caused by drift while utilizing the positioning result of the second process in which accuracy tends to be higher than that of the first process. Consequently, the positioning accuracy in the first process can be effectively improved, and the positioning accuracy in the entire the positioning system 10 can be effectively improved.

### B. Second Embodiment

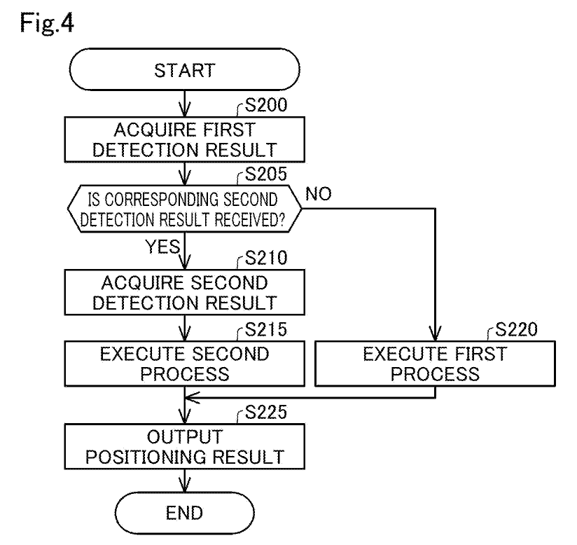

FIG. 4 is a flow chart of the position identification process in the second embodiment. Unlike the first embodiment, in the present embodiment, the position identification unit 110 performs the positioning process of one of the first process and the second process according to whether or not the second detection result is received by the communication device 105 serving as the receiving unit, instead of depending on the area. In the present embodiment, the processor 101 of the position identification device 100 may not function as the area identification unit 115 and the determination unit 120. In the present embodiment, The memory 102 may not store the database DM. In the configuration of the positioning system 10 and the position identification device 100 according to the second embodiment, points not specifically described are the same as in the first embodiment.

In step S200, the position identification unit 110 acquires the most recent first detection result received by the communication device 105. In step S205, the position identification unit 110 determines whether the second detection result corresponding in time to the first detection result acquired in step S200 has been received by the communication device 105. When the second detection result is received at step S205, in step S210, the position identification unit 110 acquires the second detection result. In step S215, the position identification unit 110 performs the second process using the first detection result acquired by step S200 and the second detection result acquired by step S215. When the second detection result is not received at step S205, in step S220, the position identification unit 110 performs the first process using the first detection result acquired at step S200. Step S225 is substantially the same as step S115 of FIG. 2.

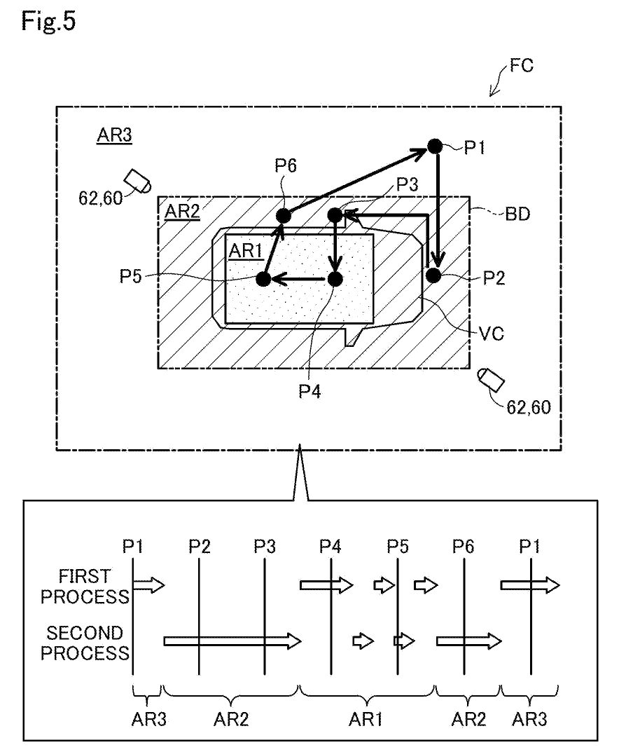

FIG. 5 is a diagram for explaining an exemplary position identification process in the second embodiment. In the example of FIG. 5, unlike FIG. 3, a process executed as the positioning processing is switched between the first process and the second process according to whether the second detection result is received or not. For example, in the example of FIG. 5, unlike FIG. 3, the first processing is not continued while the worker WK moves from position P4 to position P5, but the first processing and the second processing are appropriately switched. In the second embodiment, as the first embodiment, when the first process is executed immediately after the second process, the position identification unit 110 identifies the position of the worker WK by using the position of the worker WK identified by the second process immediately before as the reference position and calculating the displacement from the reference position using the first detection result.

According to the second embodiment described above, when only the first detection result among the first detection result and the second detection result is received, the first process is executed. When the first detection result and the second detection result corresponding to each other in time are received, the second process is executed. Therefore, according to whether or not the second detection result is received, the first processing and the second processing can be more flexibly used in a selective manner, thereby further improving the positioning accuracy and the robustness of positioning in the positioning system 10. Further, in the second processing, not only the second detection result but also the first detection result is used, so that, as in the first embodiment, the convenience of the positioning system 10 can be improved. In particular, in the present embodiment, in the second process, at least the position of the foot of the worker WK is identified using the posture of the worker WK calculated using the first detection result and the position of the head of the worker WK represented by the second detection result. As a result, it is possible to obtain a positioning result with higher accuracy and usefulness while suppressing the operation of the worker WK from being inhibited by the mounted tracker 61.

It should be noted that, in other embodiments, for example, control in which the positioning process is determined for each area as in the first embodiment and control in which the positioning process is determined according to whether or not the second detection result is received as in the second embodiment may be applied in combination. For example, in the examples of FIG. 3 and FIG. 5, the position identification unit 110 may execute only the first process among the first process and the second process in the second area AR2, and may execute either the first processing or the second process as a positioning process in the first area AR1 according to whether or not the second detection result is received.

### C. Other Embodiments

(C1) In the above-described embodiments, although either the first process and the second process is executed, it is not limited thereto. For example, one of the first process and the third process may be executed. The third process identifies the position of the worker WK using the second detection result and without using the first detection result. The third process may be, for example, simply a process of identifying the position of the worker WK using the position based on the second detection result, or a process of identifying the position of the worker WK using the position based on the second detection result and the predetermined posture information.

(C2) In the above-described embodiments, the single tracker 61 is worn by the worker WK. In contrast, two or more trackers 61 may be worn by the worker WK. When two or more trackers 61 are worn by the worker WK, the angular relationship between the trackers 61 can be detected from the positional relationship between the trackers 61. When two or more trackers 61 are worn by the worker WK, in the second process, the position identification unit 110 may position the worker WK using the angular relation between the trackers 61 in addition to or in place of the position of the tracker 61. More specifically, in the second process, for example, the position identification unit 110 may correct the posture calculated by using the integration of the angular velocity detected by the posture sensor 50 using the angular relation between the trackers 61 and position the worker WK using the corrected posture. Although the posture calculated by using the integral of the angular velocity may be affected by the drift, by correcting the posture using the angular relation between the trackers 61 as described above, it is possible to suppress the influence of such drift from affecting the positioning result obtained by the second process. Consequently, the worker WK can be positioned with higher accuracy in the second process.

(C3) In the above-described embodiments, for example, the position identification unit 110 may use at least one detection result of the first detection result and the second detection result according to time. More specifically, for example, in a case where a work process including a plurality of operations is repeatedly performed as one cycle, the position identification unit 110 may execute either the first process or the second process as the positioning process according to an elapsed time from a work start timing of the one cycle process. In this case, it is preferable that each operation included in the work process is a operation in which its operation time is less likely to vary, for example, depending on the proficiency of the worker WK or the external environment.

(C4) In the above-described embodiments, in the positioning process, at least the position of the foot of the worker WK is identified as the position of the worker WK, but the position of the foot may not be identified.

(C5) In the above-described embodiments, in the first process immediately after the second process, the position of the worker WK identified in the immediately before second process is used as the reference position, but it is not limited thereto. For example, in the first process immediately after the second process, the position of the worker WK estimated using an external sensor such as a camera or an area sensor may be used as the reference position.

(C6) In the above-described embodiments, the factory FC is a factory for manufacturing the vehicle VC, but is not limited thereto. For example, the factory FC may be various factories such as an inspection factory for the vehicle VC, a manufacturing factory or an inspection factory of various articles other than the vehicle VC. The positioning system 10 may be used not only in the factory FC but also in various workshops where the worker WK performs an operation.

(C7) In the above-described embodiments, some or all of the functional portions such as the position identification unit 110, the area identification unit 115, the determination unit 120, and the processing unit 190 may be provided in an external device such as an external computer that differs from the position identification unit 110, for example.

In the above-described embodiments, some or all of the functions and processes implemented by software may alternatively be implemented by hardware. Conversely, some or all of the functions and processes implemented by hardware may alternatively be implemented by software. As hardware for realizing various functions in the above embodiments, various circuits such as integrated circuits and discrete circuits may be used.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the present disclosure, a positioning system positioning a worker is provided. The positioning system includes: a posture sensor worn by the worker, the posture sensor detecting a physical quantity relating to a change in posture of the worker; an optical tracker device optically detecting a physical quantity representing a position of a tracker worn by the worker; and a position identification unit identifying a position of the worker by selectively using at least one detection result of first detection result by the posture sensor and second detection result by the optical tracker device in a plurality of patterns.

According to this aspect, the position of the worker can be identified by selectively using at least one detection result of first detection result that is easily detected regardless of the position of the worker and second detection result that accurately represents the position of the tracker, thereby ensuring positioning accuracy and positioning robustness in the positioning system.

(2) In the aspect described above, the position identification unit may selectively use the at least one detection result in the plurality of patterns according to an area in which the worker is located.

According to this aspect, positioning accuracy and positioning robustness can be ensured in the positioning system while managing the detection result used for positioning for each area.

(3) In the aspect described above, the positioning system may further comprise a receiving unit configured to receive the first detection result from the posture sensor and the second detection result from the optical tracker device. The position identification unit may use the at least one detection result received by the receiving unit selectively in the plurality of patterns. When only the first detection result among the first detection result and the second detection result is received by the receiving unit, the position identification unit may use the first detection result and execute a first process of identifying the position of the worker without using the second detection result. When the first detection result and the second detection result that temporally correspond to each other are received by the receiving unit, the position identification unit may execute a second process of identifying the position of the worker using the first detection result and the second detection result.

According to this aspect, depending on whether or not the second detection result has been received, the first process that does not use the second detection result and the second process that uses the second detection result can be selectively used, thereby further increasing the positioning accuracy and the positioning robustness in the positioning system.

(4) In the aspect described above, the position identification unit may identify, as the position of the worker, at least a position of a foot of the worker. The tracker may be mounted on a head of the worker. The second process may be a process of identifying at least the position of the foot using the posture calculated using the first detection result and a position of the head represented by the second detection result.

According to this aspect, it is possible to obtain positioning result with higher accuracy and usefulness while suppressing the worker operation from being inhibited by the worn tracker.

(5) In the aspect described above, when executing the first process immediately after the second process, the position identification unit may identify the position of the worker by using the position of the worker identified by the second process executed immediately before as a reference position and calculating a displacement from the reference position using the first detection result.

According to this embodiment, in the first processing, it is possible to suppress a decrease in the positioning accuracy caused by the drift while utilizing the positioning result of the second processing in which the accuracy tends to be higher than that of the first processing.

The present disclosure can be implemented not only in the form of the positioning system described above, but also in the form of, for example, a position identifying device, a positioning method, a program for implementing the positioning method, a non-transitory recording medium on which the program is recorded, or a program product. The program product may be provided, for example, as a recording medium on which the program is recorded, or as a program product distributable via a network.

What is claimed is:

1. A positioning system positioning a worker, comprising:
a posture sensor worn by the worker, the posture sensor detecting a physical quantity relating to a change in posture of the worker;
an optical tracker device optically detecting a physical quantity representing a position of a tracker worn by the worker; and
a position identification unit identifying a position of the worker by selectively using at least one detection result of first detection result by the posture sensor and second detection result by the optical tracker device in a plurality of patterns.

2. The positioning system according to claim 1, wherein
the position identification unit selectively uses the at least one detection result in the plurality of patterns according to an area in which the worker is located.

3. The positioning system according to claim 1, further comprising,
A receiving unit configured to receive the first detection result from the posture sensor and the second detection result from the optical tracker device, wherein the position identification unit
uses the at least one detection result received by the receiving unit selectively in the plurality of patterns,
when only the first detection result among the first detection result and the second detection result is received by the receiving unit, uses the first detection result and executes a first process of identifying the position of the worker without using the second detection result, and
when the first detection result and the second detection result that temporally correspond to each other are received by the receiving unit, executes a second process of identifying the position of the worker using the first detection result and the second detection result.

4. The positioning system according to claim 3, wherein
the position identification unit identifies, as the position of the worker, at least a position of a foot of the worker,
the tracker is mounted on a head of the worker, and
the second process is a process of identifying at least the position of the foot using the posture calculated using the first detection result and a position of the head represented by the second detection result.

5. The positioning system according to claim 3, wherein when executing the first process immediately after the second process, the position identification unit identifies the position of the worker by using the position of the worker identified by the second process executed immediately before as a reference position and calculating a displacement from the reference position using the first detection result.
